(19) United States
(12) Patent Application Publication
(10) Pub. No.: US 2008/0061697 A1
(43) Pub. Date: Mar. 13, 2008

(54) Plasma display panel

(76) Inventors: Yoshitaka Terao, Yokohama-shi (JP); Yukika Yamada, Yokohama-shi (JP); Takashi Miyama, Yokohama-shi (JP)

Correspondence Address: ROBERT E. BUSHNELL, 1522 K STREET NW, SUITE 300, WASHINGTON, DC, 20005-1202, US

(21) Appl. No.: 11/898,217

(22) Filed: Sep. 10, 2007

(30) Foreign Application Priority Data
Sep. 11, 2006 (JP) 2006-245361
May 31, 2007 (KR) 10-2007-0053349

(51) Int. Cl. H01J 17/49

(52) U.S. Cl. 313/584

(57) ABSTRACT

A plasma display panel (PDP) improves discharge efficiency of each discharge cell without reduction of the opening area of the discharge cells corresponding to each pixel. The PDP includes a front substrate, a rear substrate facing the front substrate, and a barrier rib disposed between the front substrate and the rear substrate for partitioning a plurality of discharge cells. The barrier rib includes a plurality of first and second barrier ribs, first electrodes, second electrodes, and branch electrodes. The first barrier ribs are formed in a first direction, and the second barrier ribs are formed in a second direction which crosses the first direction. The first electrodes are formed in the first barrier ribs at an interval of N first barrier ribs among the first barrier ribs arranged in the first direction, where N is a natural number. The second electrodes are formed in the second barrier ribs so as to cross the first electrodes three-dimensionally. The branch electrodes are disposed in the second barrier ribs, overlapping with at least one of the second electrodes, and extending from the first electrodes.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 31 of May 2007 and there duly assigned Serial No. 10-2007-0053349, and also filed in the Japanese Patent Office on the 11 of Sep. 2006 and there duly assigned Serial No. 10-2007-0053349.

### BACKGROUND OF THE INVENTION

1. Technical Field

The present invention relates to a plasma display panel. More particularly, the present invention relates to an electrode structure for a plasma display panel.

2. Related Art

As known, a plasma display panel (hereinafter, referred to as “PDP”) having a three-electrode surface-discharge structure, which is capable of efficiently emitting light, has been mainly developed.

However, in order to enhance the luminance of a PDP, the electrode structure and barrier rib shape must be improved, and the luminous efficiency by plasma discharge and the aperture ratio of discharge cells must be increased. A variety of technical improvement in the kind of discharge gas included in discharge cells or the mixing ratio of the discharge gas has been made.

Yet, much interest is focused on an electrode structure that directly affects the luminous efficiency, and, therefore, many study results on the electrode structure have been and are being published.

For instance, a PDP having a ring-type electrode structure is disclosed in Japanese Patent Laid-Open No. 2005-276810. According to the Japanese Patent Laid-Open No. 2005-276810, in order to improve the luminous efficiency of a PDP, the PDP has an electrode structure wherein a pair of discharge electrodes are disposed in a barrier rib which partitions discharge cells, and a ring-type electrode loop surrounding the discharge cells is formed. A ladder-type electrode structure in which ring-type electrodes are connected is also known.

If the ring-type electrode structure is employed, a discharge path is formed around each side wall surface of a discharge cell, and plasma is concentrated at the center. Therefore, plasma discharge can be more effectively induced to emit light. However, it is necessary to make the opening diameter of a discharge cell sufficiently small in order to concentrate plasma at the center of the discharge cell. Due to the small opening diameter, the light emitting area becomes smaller by as much as the reduction in the opening diameter, and the luminance of a PDP becomes deteriorated.

Conversely, if the opening diameter of a discharge cell becomes larger, plasma cannot be sufficiently concentrated at the center. As a result, each discharge cell cannot provide high luminous efficiency.

The above information disclosed in this Background section is only for enhancement of an understanding of the background of the invention, and therefore it may contain information that does not form the prior art which is already known in this country to a person of ordinary skill in the art.

### SUMMARY OF THE INVENTION

The present invention has been developed in an effort to provide a plasma display panel having the advantage of high efficiency of plasma discharge induced from each discharge cell without reduction in the opening area of discharge cells corresponding to each pixel.

It is an object of the present invention to provide a plasma display panel (PDP) for effectively inducing plasma discharge from each of discharge cells without reduction in the opening area of discharge cells corresponding to each pixel.

An exemplary embodiment of the present invention provides a plasma display panel (PDP) including a front substrate, a rear substrate facing the front substrate, and a barrier rib disposed between the front substrate and the rear substrate for partitioning a plurality of discharge cells. The barrier rib includes a plurality of first and second barrier ribs, first electrodes, second electrodes, and branch electrodes. The first barrier ribs are formed in a first direction, and the second barrier ribs are formed in a second direction which crosses the first direction. The first electrodes are formed in the first barrier ribs at an interval of N first barrier ribs among the first barrier ribs arranged in the first direction where N is a natural number. The second electrodes are formed in the second barrier ribs so as to cross the first electrodes three-dimensionally. The branch electrodes are disposed in the second barrier ribs, overlapping with at least one of the second electrodes, and extending from the first electrodes.

Therefore, a plurality of the small discharge cells forming a sub-pixel may simultaneously emit light by the branch electrode and the second electrode. The plasma discharge generated from each of the discharge cells improves luminous efficiency, and an open area of discharge cells is sufficiently secured. As a result, high luminance of plasma light emitting is achieved.

The first electrode may include a pair of sub-electrodes disposed at both sides of a discharge cell. Therefore, the efficiency of plasma discharge generated from each of the discharge cells is improved.

The first electrode may further include a bridge electrode which connects a pair of the sub-electrodes. Therefore, the efficiency of plasma discharge generated from each of the discharge cells is improved.

The first electrode and the second electrode may be included in the barrier rib so as to partition the discharge cells. Therefore, each electrode is prevented from ion sputtering, and it is possible to achieve the sidewall discharge type surface discharge which forms a discharge path around the side wall surface of discharge cells.

The branch electrode may be disposed directly on the first electrode or directly below the first electrode. Therefore, the plasma discharge is more effectively induced between the branch electrode and the first electrode.

The discharge cell may have a cross section in a circular shape or in a polygon shape. Therefore, it is possible to dispose more discharge cells in a constant area and to form a wider opening area.

Also, the plasma display panel may further include third electrodes having the same shape of the first electrode, separated from the first electrode at a distance so as to insert the second electrode therebetween, and inducing plasma discharge between the first electrode and the second electrode.

According to the configuration, it is possible to form a three-electrode type discharge structure with the second electrode as an address electrode and the first and third electrodes as a scan and sustain electrode.

The plasma display panel may further include third electrodes having the same shape as the second electrode, separated from the second electrode at a distance so as to insert the first electrode therebetween, and inducing plasma discharge between the second electrode and the first electrode.

According to the configuration, it is possible to form a three-electrode type discharge structure with the first electrode as an address electrode and the second and third electrodes as a scan and sustain electrode.

As described above, each of the discharge cells effectively generates plasma discharge without reduction in the opening area of discharge cells corresponding to each pixel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a plasma display panel (PDP) according to a first exemplary embodiment of the present invention.

FIG. 2 is a Y-Z cross-sectional view taken along the line I-I of FIG. 1.

FIG. 3 is an X-Z cross-sectional view taken along the line II-II of FIG. 1.

FIG. 4 is an X-Y cross-sectional view taken along the line III-III of FIG. 1.

FIG. 5 is a schematic diagram illustrating an electrode structure of a plasma display panel according to the first exemplary embodiment of the present invention.

FIG. 6 is an X-Y cross-sectional view of a plasma display panel according to a first exemplary variation of the first exemplary embodiment of the invention taken along the line III-III of FIG. 1.

FIG. 7 is an X-Y cross-sectional view of a plasma display panel according to a second variation of the first exemplary embodiment taken along the line III-III of FIG. 1.

FIG. 8 is an X-Y cross-sectional view of a plasma display panel according to a third variation of the first exemplary embodiment taken along the line III-III of FIG. 1.

FIG. 9 is a Z-Y cross-sectional view of a plasma display panel according to a fourth exemplary variation of the first exemplary embodiment taken along the line I-I of FIG. 1.

FIG. 10 is a Z-Y cross-sectional view of a plasma display panel according to a fifth exemplary variation of the first exemplary embodiment taken along the line I-I of FIG. 1.

FIG. 11 is a perspective view of a plasma display panel (PDP) according to a second exemplary embodiment of the present invention.

FIG. 12 is a Y-Z cross-sectional view taken along the line I-I of FIG. 11.

FIG. 13 is an X-Z cross-sectional view taken along the line II-II of FIG. 11.

FIG. 14 is an X-Y cross-sectional view taken along the line III-III of FIG. 11.

FIG. 15 is an X-Y cross-sectional view of a plasma display panel according to an exemplary variation of the second exemplary embodiment of the invention taken along the line III-III of FIG. 11.

### DETAILED DESCRIPTION OF THE INVENTION

The present invention will be described in detail hereinafter with reference to the accompanying drawings, in which exemplary embodiments of the invention are shown. As those skilled in the art will realize, the described embodiments may be modified in various different ways, all without departing from the spirit or scope of the present invention. Throughout the specification, it is noted that, for the purpose of clarity, parts which are not relevant to the detailed description of the present invention will be omitted, and the same reference numerals will be used for like or equivalent constituent elements.

First, a PDP according to the first exemplary embodiment of the present invention will be described.

The present exemplary embodiment is characterized in that a PDP generates plasma discharge in a plurality of discharge cells with the same timing using at least a pair of electrodes.

For example, a pair of electrodes may be an address electrode and a scan electrode. The first electrode may be an address electrode, and the second electrode may be a scan electrode.

According to the present exemplary embodiment, in the electrode structure of a PDP in which a plurality of discharge cells are partitioned, the plurality of discharge cells having a small aperture diameter can emit light simultaneously by means of a pair of electrodes, plasma discharge for each discharge cell can be efficiently performed, and the total aperture area of the discharge cells assigned to each pixel can be made sufficient.

The entire configuration of a PDP, the disposition and shape of electrodes, and the effect thereofin accordance with the present exemplary embodiment will be described hereinafter.

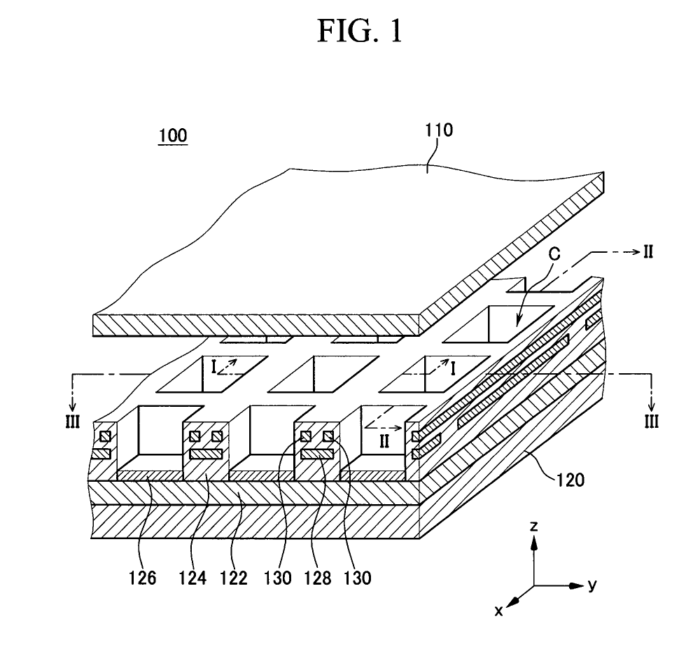

The entire configuration of a PDP according to the present exemplary embodiment will now be explained with reference to FIG. 1, which is a perspective view illustrating the entire configuration of a PDP according to the first exemplary embodiment of the present invention.

Moreover, FIG. 1 is a schematic diagram illustrating a PDP 100 for the purpose of describing the characteristics of the present embodiment. Parameters such as width, height, thickness, or depth of each constituent element may vary according to the embodiments of the present invention except for parameters clearly defined in the specification.

Therefore, if any configuration has the technical characteristics of the present embodiments which will be described hereinafter, it will be understood as one of the exemplary embodiments included in the technical scope of the present invention. In the accompanying drawings, identically hatched blocks denote the same constituent elements.

The PDP 100 according to the present exemplary embodiment includes a front substrate 110, a rear substrate 120, a dielectric layer 122, barrier ribs 124, a phosphor layer 126, first electrodes 128 (hereinafter, referred to as “scan electrodes”), and second electrodes 130 (hereinafter, referred to as “address electrodes”). Here, the spaces partitioned by the barrier ribs 124 between the front substrate 110 and the rear substrate 120 are called discharge cells C.

The front substrate 110 is disposed in front of the PDP 100 and is made of a transparent material which can transmit visible light generated from the discharge cells C. For example, the front substrate 110 may be made of soda lime glass.

The surface of the front substrate 110 may be coated with SiO₂ or the like. Also, a phosphor layer may be formed on the front substrate 110, i.e., the surface partitioning the discharge cells.

The front substrate 110 also functions as a lid for sealing discharge gas filled in the discharge cells C.

The discharge gas may be an inactive gas (rare gas), such as Xe and Ne, or a mixture thereof. However, the discharge gas used for the PDP 100 of the present exemplary embodiment is not limited as to type.

The rear substrate 120 is disposed facing the front substrate 110 and constituent elements, such as the discharge cells which are necessary for plasma discharge, are formed on the rear substrate 120.

The rear substrate 120 may be made of the same material as the front substrate 110. It is desirable to form the rear substrate 120 as thinly as possible because the thickness of the front and rear substrates 110 and 120, respectively, is a main factor in determining the thickness of a PDP. Particularly, it is preferable to make the front substrate 110 much thinner so as to increase the transmittance of visible light generated from the discharge cells C.

The dielectric layer 122 is an insulation layer formed over the rear substrate 120. As is well known, the PDP 100 generates gas discharge by ionizing the discharge gas in the discharge cells through a potential difference generated between at least a pair of electrodes.

Thus, it is not desirable to expose a conductivity member to the discharge cells C. Although the rear substrate 120 is made of a dielectric material such as soda lime glass in most cases, insulation cannot always be guaranteed due to many conditions, such as temperature.

Although it is not shown in FIG. 1, the dielectric layer 122 may be disposed on the rear substrate 120 so as to cover the electrodes and insulate them.

The dielectric layer 122 may be made of a dielectric material of which the main component is, for example, PbO, B₂O₃, or SiO₂.

The barrier ribs 124 are formed between the front substrate 110 and the rear substrate 120 so as to partition the discharge cells C. Each barrier rib 124 may be made of the same dielectric material as the dielectric layer 122.

Unlike a typical three-electrode surface-discharge type PDP, the PDP 100 according to the present exemplary embodiment generates plasma discharge using a pair of electrodes formed inside the barrier ribs 124.

Therefore, the barrier ribs 124 protect electrodes from sputtering caused by the collision of ion particles, and act as an actual electrode surface for charging wall charge thereon.

Although it is not shown in FIG. 1, a phosphor may be applied onto the surface of the barrier ribs 124 so as to form a light emitting surface.

In general, the phosphor is white, and it reflects visible light generated from the phosphor layer 126 so as to improve the luminance not only when the ultraviolet UV generated by the plasma discharge reaches the surface directly but also when the ultraviolet UV does not reach the surface directly.

The barrier ribs 124 forming the walls of the discharge cells C include first barrier ribs (hereinafter, referred to as “X barrier ribs”) which form vertical walls in the X direction and second barrier ribs (hereinafter, referred to as “Y barrier ribs”) which form vertical walls in the Y direction.

Each of the X barrier ribs and Y barrier ribs forms a part of the barrier ribs 124 integrally formed, and partitions the discharge cells C.

The phosphor layer 126 may be made of an ultraviolet excitation phosphor which absorbs ultraviolet light and emits a specific wavelength of light, particularly, visible light. That is, the phosphor layer 126 receives the ultraviolet light emitted upon plasma discharge generated in the discharge cells C and emits visible light.

Generally, the phosphor material for the phosphor layer 126 may consist of a material for emitting red light such as (Y, Gd)BO₃:Eu, or Y₂O₃:Eu, a material for emitting green light such as Zn₂SiO₄:Mn or BaAl₁₂O₁₉:Mn, and a material for emitting blue light such as BaMgAl₁₄O₂₃:Eu.

As shown in FIG. 1, in the present exemplary embodiment, the phosphor layer 126 is disposed on the dielectric layer 122 and the bottom of the discharge cells C. However, the phosphor layer 126 may be disposed on at least one surface of the barrier ribs 124 or on the surface of the front substrate 110 bordering the discharge cells C.

The scan electrode 128 generates a potential difference between itself and the address electrode 130, and ionizes discharge gas in the discharge cell C.

In the present exemplary embodiment, the scan electrode 128 is formed inside the barrier rib 124, and a configuration in which the entire surface of the scan electrode 128 is covered with a dielectric material (the barrier rib 124) is shown.

The scan electrode 128 includes a line unit extending in the Y direction and a branch unit extending in the X direction, which is perpendicular to the line unit. The line unit and the branch unit may be integrally formed as a part of the scan electrode 128. Hereinafter, the branch unit of the scan electrode 128 is called a branch electrode.

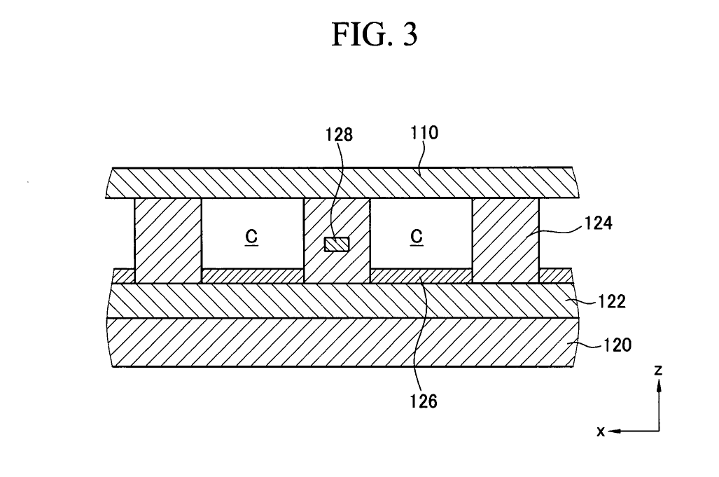

FIG. 3 is an X-Z cross-sectional view taken along the line II-II of FIG. 1.

More specifically, FIG. 3 illustrates a perspective view of the PDP 100. In FIG. 3, the cross-section of the branch electrode of the scan electrode 128 is shown.

Particularly, the branch electrode of the scan electrode 128 located at the center of FIG. 3 extends in correspondence to the side of the two adjacent discharge cells C, and has a length equivalent to the sum of the widths of the two discharge cells C and the width of the barrier rib 124 partitioning the discharge cells.

The address electrode 130 generates a potential difference between itself and the scan electrode 128 so as to ionize the discharge gas in the discharge cells C.

Although it is not clearly shown in FIG. 1, the address electrode 130 crosses the scan electrode 128 separated by a predetermined distance in the Z direction.

In other words, the address electrode 130 has a linear structure extending in the X direction and has a location relationship perpendicular to the scan electrode 128 extending in the Y direction.

Also, the address electrode 130 is disposed over the branch electrode of the scan electrode 128 extending in the X direction by a predetermined distance so as to form a discharge path between itself and the branch electrode.

Separate electrodes, each forming two address electrodes 130, are disposed in parallel to the Y direction by a predetermined distance in the Y barrier rib of the barrier rib 124 according to the present exemplary embodiment.

Therefore, the address electrodes 130 are partitioned by the Y barrier rib, and each is disposed on both walls of two adjacent discharge cells C.

In other words, each discharge path is formed between the address electrodes 130, disposed in two Y barrier ribs which forms both walls of each discharge cell C, and the branch electrode of the scan electrode 128, and plasma discharge is induced through the discharge path.

In this respect, a pair of address electrodes 130 corresponding to both walls of a discharge cell should be formed so as to interact with each other. The reason is that plasma discharge should be generated simultaneously from both walls of a discharge cell C.

Even if the plasma discharge is not generated simultaneously, it may be possible to cause the discharge cell C to emit light. However, such a configuration is not considered in the present invention.

In this case, each of the separate electrodes forming a pair of address electrodes 130 is called a sub-electrode.

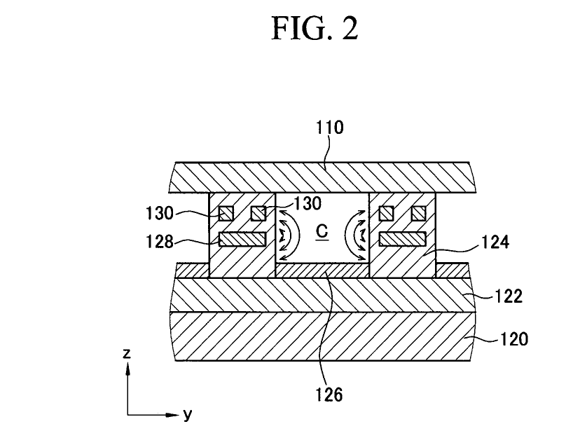

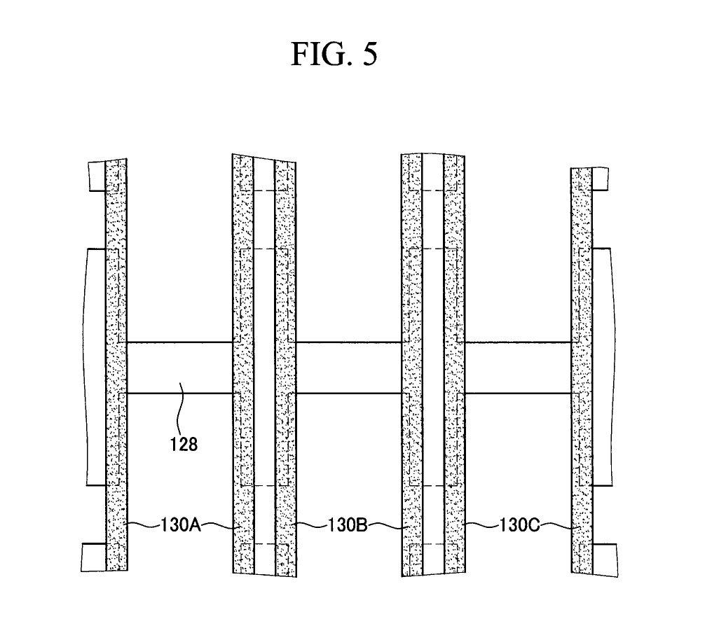

The disposition and shape of the electrodes of a PDP 100 according to the present exemplary embodiment will be described in detail with reference to FIG. 2 thru FIG. 5.

FIG. 2 is a Y-Z cross-sectional view taken along the line I-I of FIG. 1.

Referring to FIG. 2, the PDP 100 according to the present exemplary embodiment includes a front substrate 110, a rear substrate 120, a dielectric layer 122, barrier ribs 124, a phosphor layer 126, scan electrodes 128, and address electrodes 130, and it has almost the same structure as a typical PDP except for the disposition of the scan and address electrodes 128 and 130, respectively.

Thus, the structure of the scan and address electrodes 128 and 130, respectively, will be further described in detail.

As mentioned above, one of the main characteristics of the PDP 100 according to the present exemplary embodiment is to dispose the scan and address electrodes 128 and 130, respectively, inside the barrier ribs 124.

In a typical three-electrode surface-discharge type PDP, scan and sustain electrodes are disposed on the front substrate 110, and address electrodes are disposed between the rear substrate 120 and dielectric layer 122.

Also, in a typical AC discharge type PDP, scan electrodes are disposed on the front substrate 110, and address electrodes are disposed between the rear substrate 120 and dielectric layer 122.

In general, electrodes disposed on the front substrate 110 use a transparent electrode such as ITO (Indium Tin Oxide) so as not to block visible light passing through the front substrate 110.

Therefore, if an electrode is disposed on the front substrate 110, a dielectric layer and a protection layer, for example, an MgO layer, should be formed on the front substrate 110 to cover at least the transparent electrode.

However, since the transparent electrode, dielectric layer and protection layer are stacked on the front substrate 110, the thickness of the layer through which the visible light passes becomes thicker, thereby deteriorating the luminance of the PDP.

Conversely, since the PDP 100 according to the present exemplary embodiment has an electrode structure where the scan and address electrodes 128 and 130, respectively, are disposed in the barrier rib 124, the transparent electrode, dielectric layer and protection layer can be omitted, therefore, improving the transmittance of the visible light.

Accordingly, the discharge structure for the PDP 100 of the present exemplary embodiment is similar to that of a typical AC type PDP.

That is, the PDP 100 generates a potential difference between the scan electrode 128 and the address electrode 130 so as to ionize the discharge gas in the discharge cell C, and to generate wall charge on the surface of the barrier rib 124.

In addition, while reversing the polarities of the scan and address electrodes 128 and electrodes 130, respectively, the PDP 100 generates a sustain discharge.

Therefore, the PDP 100 has a sidewall discharge type of discharge structure where a discharge path is formed on the surface of the barrier rib 124.

The arrows with two heads on the surface of the barrier rib 124 in FIG. 2 show the discharge path of the sidewall discharge type.

However, in addition to the path expressed by the arrows, the discharge path in the discharge cell is also formed between the scan electrode 128 and the address electrode 130 which are disposed facing each other.

Thus, the PDP 100 according to the present exemplary embodiment has a sidewall discharge structure where the scan and address electrodes 128 and 130, respectively, are disposed on both walls of the discharge cell C so that a plasma discharge is generated from the both walls of the discharge cell C.

Accordingly, the PDP 100 of the present exemplary embodiment improves the discharge efficiency of each discharge cell C, and then the luminous efficiency of the PDP 100.

Note that the disposition of the address electrodes 130 contributes to the plasma discharge in each discharge cell C.

More specifically, the address electrodes which contribute to the plasma discharge in the discharge cell C of FIG. 2 are the right sub-electrode of the two address electrodes 130 disposed in the barrier rib located at the left of the discharge cell C, and the left sub-electrode of the two address electrodes disposed in the barrier rib 124 located at the right of the discharge cell C.

Meanwhile, the others of the address electrodes 130, which do not contribute to the plasma discharge in the discharge cell C, contribute to plasma discharge in adjacent discharge cells, respectively.

Although not shown in FIG. 1 and FIG. 2, the address electrodes 130 have a linear structure extending in the depth direction of FIG. 2, i.e., the X direction.

FIG. 2 shows a cross-section of the branch electrode of the scan electrode 128. The address electrode 130 and the branch electrode of the scan electrode 128 mainly contribute to the plasma discharge in the discharge cell C.

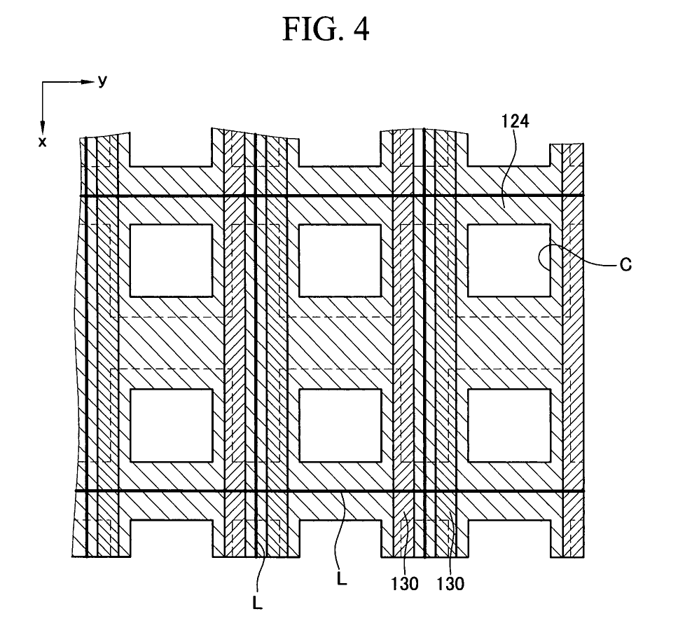

Thus, it is desirable to dispose the branch electrode of the scan electrode 128 in the Y barrier rib corresponding to the discharge cell C, as shown in FIG. 2, so that plasma discharge can be generated in the entire X direction of the Y barrier rib (see FIG. 4).

Also, each of the two Y barrier ribs partitioning the discharge cell C has a cross-sectional structure shown in FIG. 2.

FIG. 3 is an X-Z cross-sectional view taken along the line II-II of FIG. 1.

Referring to FIG. 3, in a PDP 100 according to the present exemplary embodiment, two discharge cells constitute one sub-pixel. In general, one pixel is composed of a group of sub-pixels which emits red R, green G and blue B visible lights, respectively.

In a typical PDP, each sub-pixel is made up of one discharge cell C. Therefore, a phosphor layer is formed in each discharge cell adjacent to each other so as to emit a different color of visible light, respectively, in the typical PDP.

Unlike the typical PDP, in the PDP 100 of the present exemplary embodiment, a phosphor layer 126 for emitting the same color of visible light is formed in the two discharge cells which constitute one sub-pixel. That is, the phosphor layer 126 formed on the bottom of the two discharge cells of FIG. 3 absorbs ultraviolet light so as to emit the same color of visible light.

The scan electrode 128 is formed in the central barrier rib among the barrier ribs shown in FIG. 3. The cross-section of the scan electrode 128 in FIG. 3 shows a cross-section of the line unit.

The scan electrode 128 extends in the depth direction of FIG. 3, i.e., the Y direction, in the barrier rib 124 disposed between the two discharge cells of one sub-pixel.

The scan electrode 128 is formed in the central Y barrier rib of three Y barrier ribs which partition two discharge cells of one sub-pixel so that both of the two discharge cells correspond to the scan electrode 128.

Therefore, a plurality of sub-pixels in the Y direction corresponds to one scan electrode 128, and each sub-pixel corresponds to two discharge cells with the line unit of the scan electrode 128 therebetween. The position of the sub-pixel for emitting light is controlled by the address electrodes 130.

Each of the three X barrier ribs, forming the discharge cell C of FIG. 3, has the same cross-sectional structure as that of FIG. 3.

FIG. 4 is a cross-section view taken along the line III-III of FIG. 1 in an X-Y plane, and FIG. 5 is a schematic diagram illustrating an electrode structure of a plasma display panel PDP according to the first exemplary embodiment of the present invention.

FIG. 4 further clearly illustrates the electrode shape of the PDP 100, and the relation between a discharge cell C and an electrode.

Herein, a scan electrode 128 lies directly under an address electrode 130 in a barrier rib 124. Therefore, the shape of the scan electrode 128 is illustrated using a dotted line. Also, an un-hatched rectangular area denotes a discharge cell C. A thick line L is used to clearly show each sub-pixel, and a rectangular area drawn with the thick line L denotes one sub-pixel.

FIG. 5 illustrates the address electrode 130 and the scan electrode 128 of FIG. 4. Referring to FIG. 5, the electrode shape includes three pairs of address electrodes 130A, 130B, and 130C, and one scan electrode 128.

Hereinafter, two address electrodes 130a, 130b, and 130c will be described as one set. This is because one set of the address electrodes 130a, 130b, and 130c corresponds to one discharge cell C. Therefore, one set of the address electrodes 130a, 130b, and 130c is constituted so as to be interlocked by a receiving voltage.

The scan electrode 128 extends in a Y direction in parallel with an X direction.

That is, the PDP 100 has an electrode structure in which an address electrode 130 extending in the X direction crosses a scan electrode 128 extending in the Y direction. Meanwhile, a branch unit extending from the scan electrode 128 in an X direction is referred to as a branch electrode.

Hereinafter, a cross-section of the PDP 100 in an X-Y plane will be described in more detail with reference to FIG. 4.

The address electrode 130 has a linear structure extending in the X direction. The address electrode 130 according to the present exemplary embodiment is formed of a pair of sub-electrodes disposed at both sides of a discharge cell C.

For example, sub-pixels disposed at the center of FIG. 4 are formed of two discharge cells C disposed in parallel in the X direction.

The address electrodes 130 (sub-electrodes) are formed at both sides of a barrier rib 124 in the Y direction with each discharge cell as the center, in more detail, inside the barrier rib 124.

Meanwhile, a plurality of the discharge cells C arranged in the X direction corresponds to a pair of common address electrodes 130.

The scan electrode 128 includes a line unit extending in the Y direction and a branch unit elongated from the line unit in the X direction.

The branch unit (i.e., branch electrode) is formed at a lower layer of the address electrode 130 and has a length equivalent to the width of the Y barrier rib of the discharge cell C. Also, the branch unit elongates from the line unit toward both ends of the X direction.

That is, the scan electrode 128 is separated from the address electrode 130 in a depth direction (Z direction), and extends in the Y direction.

Also, two discharge cells C are disposed in the X direction of the scan electrode 128 forming an H shape in a sub pixel located at the center of FIG. 4. Such a structure is one of the characteristics of the present exemplary embodiment.

In the sub-pixel, a Y-barrier rib is disposed at the left side of the discharge cell C disposed at an upper part in the X direction. In the Y barrier rib, the branch unit of the scan electrode 128 is separated from the address electrode 130 at a predetermined distance in the depth direction or Z direction (not shown).

Therefore, the PDP 100 generates a potential difference between the branch unit of the scan electrode 128 lying under the Y barrier rib and the address electrode 130, and forms a discharge path around a Y barrier rib by ionizing a discharge gas in the discharge cell C.

As a result, the PDP 100 can induce plasma discharge in the discharge cell C by means of the branch unit of the scan electrode 128 and the address electrode 130.

Similarly, the PDP 100 induces plasma discharge in the discharge cell by means of the branch unit of the scan electrode 128 and the address electrode 130 formed in the Y barrier rib disposed at the right side of the discharge cell C.

Meanwhile, the same discharge structure is formed in a discharge cell C disposed at a lower part of a sub-pixel by a common electrode of the discharge cell C disposed at the upper part.

Therefore, the PDP 100 induces plasma discharge in a discharge cell C at the lower part and a discharge cell C at the upper part at the same time by means of the branch unit of the scan electrode 128 and the address electrode 130, which are formed in a Y barrier rib disposed at both sides in the Y direction of the discharge cell C.

That is, the scan electrode 128 and the address electrode 130 have a structure which can simultaneously induce plasma discharge at the two discharge cells C forming one sub-pixel.

Hereinafter, the operation and the effect of the plasma display panel (PDP) having the electrode structure according to the present exemplary embodiment will be described.

The PDP 100 according to the present exemplary embodiment can induce plasma discharge at a plurality of discharge cells C at the same time by means of at least one scan electrode 128 and one set of the address electrodes 130. That is, one sub-pixel includes a plurality of discharge cells C and the discharge cells C can emit light simultaneously.

In a typical PDP, one sub-pixel includes one discharge cell C. However, the electrode structure according to the present exemplary embodiment makes it possible to dispose a plurality of discharge cells C having an opening diameter shorter than the discharge cells C in the typical PDP in each of the sub-pixels.

In general, the smaller the opening diameter of the discharge cell C is, the higher the luminous efficiency becomes by plasma discharge. That is, as the product of the opening diameter D of a discharge cell C and the internal pressure P becomes smaller, the induced plasma discharge is concentrated at the center area of the discharge cell C. Also, it widens a cross-section where the ionized ions or ionized ion and electron interact. Therefore, the luminous efficiency increases. Such phenomenon is generally referred to as focusing of plasma.

Also, it is experimentally known that valid plasma focusing is induced when the multiplication of an opening diameter D (cm) and a pressure P (Torr) is smaller than about 2.

As described above, the luminous efficiency of the PDP can be improved by forming a discharge cell having a smaller opening diameter.

However, if the discharge cell is formed so as to have a small opening diameter, the opening area for emitting visible light generated in the discharge cell may be reduced. Due to the reduced opening area, the luminance may deteriorate.

Therefore, the PDP 100 according to the present exemplary embodiment has an electrode structure for allowing a plurality of small discharge cells C to be disposed, and a discharge cell structure for enabling each discharge cell C to provide high luminous efficiency and for enabling each sub-pixel to sustain sufficient opening area.

Hereinafter, exemplary variations of the first exemplary embodiment of the present invention will be described with reference to the accompanying drawings. However, like reference numerals are used for elements of the variations, which are identical or equivalent to the elements of the first exemplary embodiment, and the descriptions thereof will be omitted.

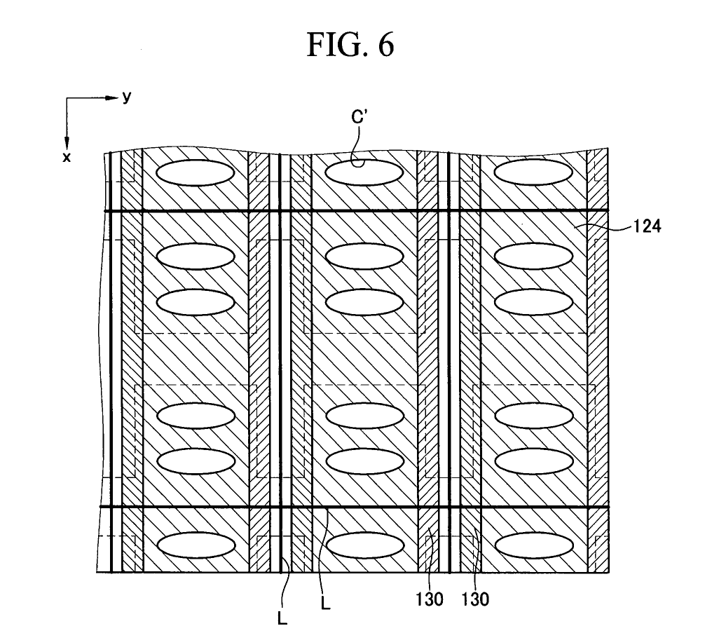

FIG. 6 is an X-Y cross-sectional view of a plasma display panel taken along the line III-III of FIG. 1 according to the first exemplary variation of the first exemplary embodiment.

Referring to FIG. 6, the first characteristic of the PDP 100 according to the first exemplary variation is that a discharge cell C′ is formed in an oval shape.

As shown in FIG. 1 thru FIG. 4, the shape of the discharge cell C according to the first exemplary embodiment is a cube or a rectangular parallelepiped, which has a rectangular X-Y cross-section.

However, the shape of the discharge cell C according to the first exemplary variation is not limited thereto. For example, the discharge cell may have the shape of an oval cylinder which has an X-Y cross-section like that of the discharge cell C′ shown in FIG. 6.

Also, the discharge cell C or C′ may be formed in a polypyramid shape which has a cone bottom, an elliptic cone bottom, a triangular pyramid bottom, or a polygon bottom. In addition, it is possible to modify the discharge cell C or C′ to have a Y-Z cross-section of a gourd dipper shape, a semi-circle shape, or a trapezoid shape.

Herein, the circular shape may include not only a true circular shape but also an oval shape although it is described as a circular shape. Also, the polygon shape may include all polygons having various angles although it is described as a polygon shape.

Meanwhile, the PDP shown in FIG. 4 and FIG. 6 includes a plurality of discharge cells C and C′ having the same size.

However, the PDP 100 according to the first exemplary variation may include a plurality of discharge cells C and C′ having different sizes or different shapes.

For example, the PDP 100 may include two types of cylindrical discharge cells C″, small and large cylindrical discharge cells, formed between the branch units of scan electrodes 128.

The described discharge cell structures allow more discharge cells C′ to be disposed compared with the same size of cylindrical discharge cells. Accordingly, a large opening area can be secured, and a high luminous PDP 100 can be realized.

The second characteristic of the PDP 100 according to the first exemplary variation is an increase in the number of discharge cells C′ disposed in a sub-pixel.

In a sub-pixel disposed at the center of FIG. 6, two discharge cells C′ are disposed in an X direction with the line unit of the scan electrode 128 as the center. Also, a scan electrode 128 (branch unit) and an address electrode 130 are commonly disposed at a Y barrier rib corresponding to the discharge cells C′.

Therefore, the discharge cells C′ induce plasma discharge at the same time by means of the scan electrode 128 and a set of the address electrodes 130 like the discharge cells C shown in FIG. 4.

That is, the number of discharge cells C′ in the PDP 100 according to the first exemplary variation shown in FIG. 6 is twice as large as that in the PDP 100 according to the first exemplary embodiment shown in FIG. 4.

However, it is obvious that each sub pixel of the PDP 100 according to the first exemplary variation shown in FIG. 6 can include small discharge cells C′ more than twice in number compared to discharge cells in the PDP 100 shown in FIG. 4.

Therefore, the maximum number of discharge cells C′ included in each sub-pixel of the PDP 100 should be decided by an actual embodiment according to the limitation of a micro electro mechanical technology at the time of embodying the PDP 100.

Also, the overall opening area of each sub-pixel can be widened by forming each discharge cell C′ so as to have a proper X-Y cross-section shape which allows discharge cells C to be disposed with the highest density.

Hereinafter, the electrode structure of the PDP 100 according to the first exemplary variation will be described.

It is proper for the scan electrode 129 and the address electrode 130 to have a linear structure in the structure of the PDP 100 having cube shaped discharge cells C according to the first exemplary embodiment as shown in FIG. 4. However, the electrode structure of the PDP I 00 according to the first exemplary variation is not limited to the linear structure.

For example, the PDP 100 may include an address electrode 130 curved along a side wall of an oval cylinder and a scan electrode 128 having a branch unit corresponding to the address electrode 130 when the cylindrical discharge cell C′ is employed as shown in FIG. 6.

Also, the PDP 100 may have a structure corresponding to two sub pixels and supplying a voltage to four address electrodes 130 which are adjacent in a Y direction so as to interact.

In the PDP 100 according to the first exemplary variation, the width (Y direction) of the sub-pixel may increase twice.

However, the size of the sub-pixel can be sustained by reducing the width of the discharge cell C′ by half and reducing the length of the line unit of the scan electrode 128 by half.

Such a variation makes it possible to form a sub-pixel which includes even more discharge cells C′.

Accordingly, the PDP 100 according to the first exemplary variation can include all of the variations shown above.

Hereinafter, a plasma display panel PDP according to the second exemplary variation of the first exemplary embodiment of the present invention will be described with reference to the accompanying drawings.

However, the descriptions of the same constituent elements in the first exemplary variation and the second exemplary variation are omitted, and the major characteristics of the PDP according to the second exemplary variation will be described.

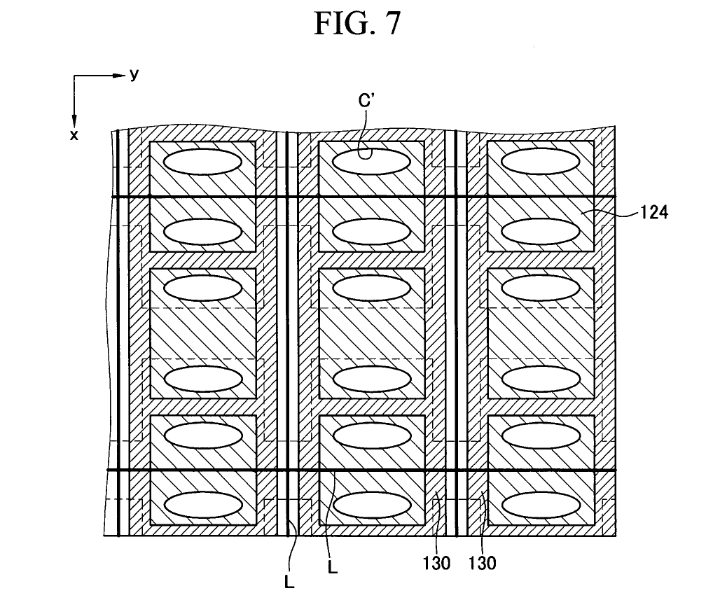

FIG. 7 is an X-Y cross sectional view of a plasma display panel PDP according to the second exemplary variation of the first exemplary embodiment taken along the line III-III of FIG. 1.

Referring to FIG. 7, the PDP 100 according to the second exemplary variation has the same electrode structure as the first exemplary variation except for the address electrode 130.

The address electrode 130 further includes a bridge electrode which connects a pair of sub electrodes disposed in Y barrier ribs at both sides of the discharge cell C′ in a Y direction.

Accordingly, the electrode structure of the second exemplary variation is formed with the combination of ladder type address electrodes 130 and scan electrodes 128 crossing the address electrodes 130.

Therefore, a plurality of discharge cells C′ may be disposed closer to an overlapping area of the scan electrodes 128 and the address electrodes 130 (crossing each other at a predetermined distance in the Z direction) in the PDP 100 according to the second exemplary variation so as to simultaneously emit light.

Meanwhile, a predetermined number of the bridge electrodes can be formed. For example, the bridge electrodes can be disposed to face the line unit of the scan electrode 128 with at least one of the discharge cells C′ interposed like the electrode structure shown in FIG. 7.

In this case, opposed discharge is induced between the bridge electrode and the line unit of the scanning electrode 128 facing the bridge electrode. The opposed discharge may deteriorate the discharge voltage in the discharge cell C′.

As another exemplary variation, the bridge electrode may be disposed above the line unit of the scan electrode 128 and separated therefrom by a predetermined distance.

In this case, when a discharge cell C′ includes a surface discharge induced by the bridge electrode and the scan electrode 128, plasma discharge is induced from three side walls. Therefore, the luminous efficiency can be further improved.

Hereinafter, a plasma display panel (PDP) according to the third exemplary variation of the first exemplary embodiment of the present invention will be described with reference to the accompanying drawings.

However, the descriptions of the same constituent elements in the first exemplary variation and the third exemplary variation are omitted, and the major characteristics of the PDP according to the third exemplary variation will be described.

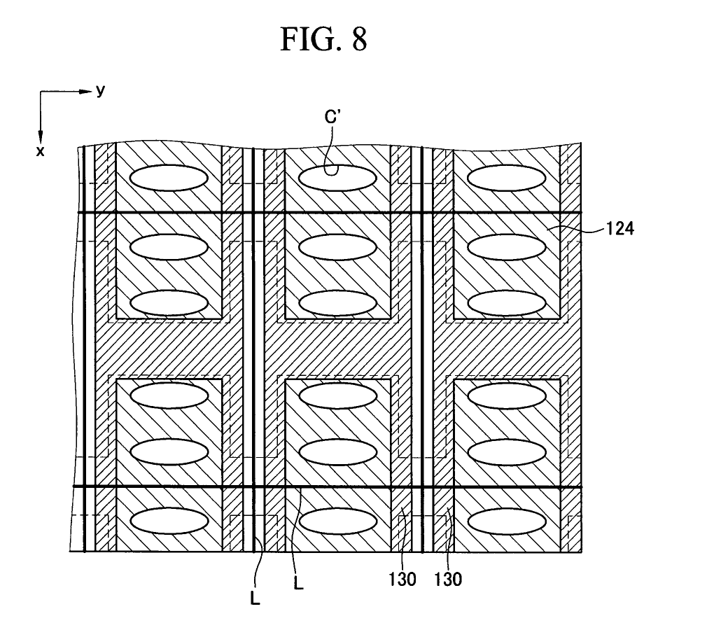

FIG. 8 is an X-Y cross-sectional view of a plasma display panel according to the third variation of the first exemplary embodiment taken along the line III-III of FIG. 1.

Referring to FIG. 8, the PDP 100 according to the third exemplary variation has the same electrode structure as the second exemplary embodiment except for an address electrode 130.

For example, the PDP 100 according to the third exemplary variation includes a bridge electrode which connects a pair of address electrodes 130 disposed at Y barrier ribs disposed at both sides of a discharge cell C′ as shown in FIG. 8.

That is, the electrode structure of the third exemplary variation is formed by the combination of ladder shaped address electrodes 130 and scan electrodes 128 crossing the address electrodes 130.

Although the electrode structure of the third exemplary variation is very similar to the electrode structure of the third exemplary embodiment shown in FIG. 7, the function of the bridge electrode is different because the bridge electrode is disposed at a different position.

That is, the bridge electrode is disposed to face the line unit of the scan electrode 128 with at least one of discharge cells C′ interposed in the electrode structure according to the third exemplary variation shown in FIG. 7. In this case, the bridge electrode deteriorates the discharge voltage of the discharge cell C′ because the bridge electrode induces an opposed discharge between the bridge electrode and the line unit of the scan electrode 128.

However, since the bridge electrode shown in FIG. 8 crosses above the lines unit of the scan electrode, the bridge electrode induces a surface discharge between the bridge electrode and the line unit of the scan electrode 128.

Therefore, a discharge path is formed around at least three side walls in a discharge cell C′ adjacent to the bridge electrode, and a plasma discharge is induced therefrom. As a result, further higher discharge efficiency can be obtained.

Hereinafter, a plasma display panel PDP according to the fourth exemplary variation of the first exemplary embodiment of the present invention will be described with reference to the accompanying drawings.

However, the descriptions of the same constituent elements in the fourth exemplary variation and the first exemplary embodiment shown in FIG. 2 are omitted, and the major feature of the PDP according to the fourth exemplary variation will be described.

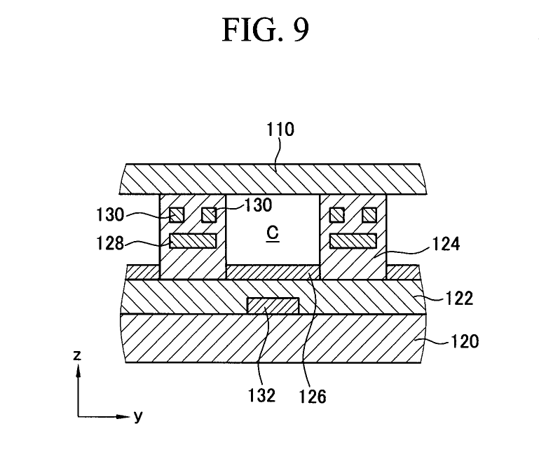

FIG. 9 is a Z-Y cross-sectional view of a plasma display panel according to the fourth exemplary variation of the first exemplary embodiment taken along the line I-I of FIG. 1.

Referring to FIG. 9, the PDP 100 according to the present exemplary embodiment further includes a floating electrode 132 with the same constituent elements as in the first exemplary embodiment shown in FIG. 2. Accordingly, the PDP 100 according to the present exemplary embodiment has the same structure as the first exemplary embodiment shown in FIG. 2 except for the floating electrode 132.

The floating electrode 132 is formed on the rear substrate 120, covered by a dielectric layer 122, and not exposed at the bottom of a discharge cell C.

The floating electrode 132 can deteriorate discharge voltage in a discharge cell C by forming a discharge path between the floating electrode and the scan electrode 128 or between the floating electrode and the address electrode 130.

Hereinafter, a plasma display panel PDP according to the fifth exemplary variation of the first exemplary embodiment of the present invention will be described with reference to the accompanying drawings. However, the descriptions of the same constituent elements in the first exemplary embodiment shown in FIG. 2 and the fifth exemplary variation are omitted, and only the major characteristic of the PDP according to the fifth exemplary variation will be described.

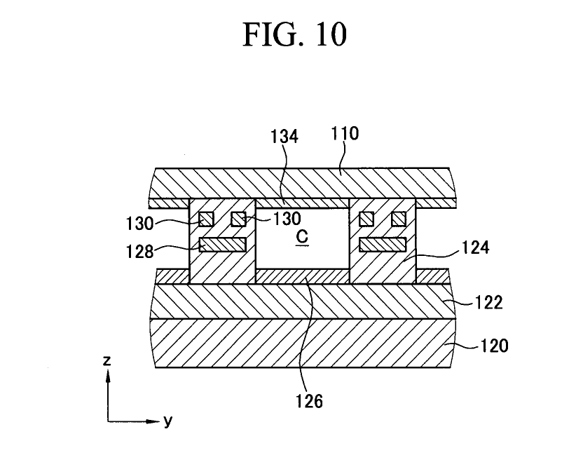

FIG. 10 is a Z-Y cross-sectional view of a plasma display panel according to the fifth exemplary variation of the first exemplary embodiment taken along the line I-I of FIG. 1.

Referring to FIG. 10, the PDP 100 according to the fifth exemplary variation further includes a phosphor layer 134 on a front substrate 110 of the PDP 100 shown in FIG. 2. Therefore, the PDP 100 according to the fifth exemplary variation has the same structure of the first exemplary embodiment shown in FIG. 2 except for the phosphor layer 134.

The phosphor layer 134 emits a visible light by absorbing ultraviolet UV permeating the front substrate 110 among ultraviolet UV generated in a discharge cell C by plasma discharge.

The visible light radiated toward the front substrate 110 permeates to the front substrate 110.

Meanwhile, the visible light radiated toward the rear substrate 120 is reflected to the front substrate 110 by the phosphor layer 126 formed on the dielectric layer 122 or the barrier rib 124. As a result, the luminance of the PDP 100 is further improved compared to that of the PDP not having the phosphor layer 134.

The overall structure, the electrode structure, and the electrode shape of the PDP 100 according to the first exemplary embodiment of the present invention were described up to now. Also, the operation and the effects of the first exemplary embodiment and the exemplary variations of the first exemplary embodiment were described.

As described above, the PDP 100 having the electrode structure according to the present embodiment can improve the luminous efficiency of each discharge cell C without the overall opening area of the corresponding discharge cells C being reduced in each sub pixel. Therefore, the PDP 100 according to the present embodiment can emit light with even higher luminance compared to a three electrode surface-discharge type PDP.

Hereinafter, a plasma display panel PDP according to the second exemplary embodiment of the present invention will be described with reference to the accompanying drawings. Herein, the descriptions of constituent elements substantially equivalent to the elements in the first exemplary embodiment are omitted, and the major characteristic of the PDP according to the second exemplary embodiment will be described.

The characteristic of the PDP 200 according to the second exemplary embodiment is to simultaneously induce plasma discharge at a plurality of discharge cells by means of a pair of electrodes.

The PDP 100 according to the first exemplary embodiment has a structure corresponding to the address electrode 130 having two sub-electrodes and the scan electrode 128 having two branch electrodes in one discharge cell.

Unlike the PDP 100 according to the first exemplary embodiment, the PDP 200 according to the second exemplary embodiment has a structure corresponding to a pair of address electrodes and scan electrodes in one discharge cell.

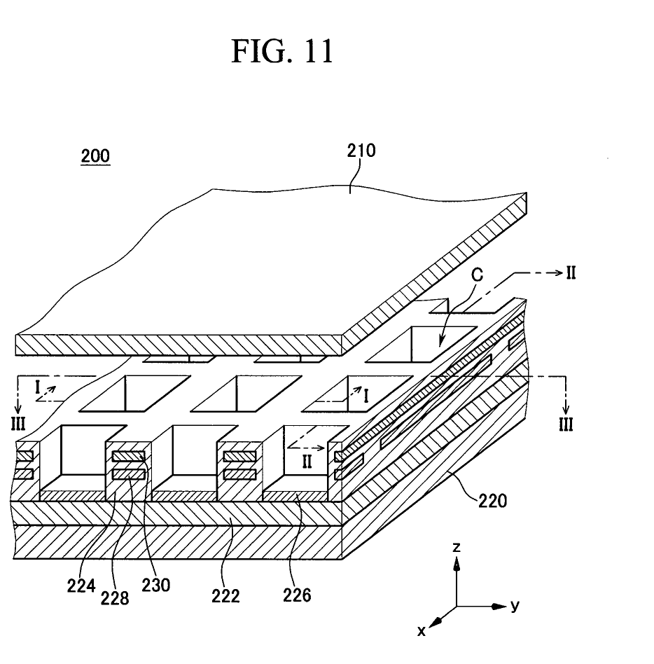

FIG. 11 is a perspective view of a plasma display panel according to the second exemplary embodiment of the present invention.

More specifically, FIG. 11 schematically shows a PDP 200 according to the second exemplary embodiment of the present invention for describing the characteristic thereof. Parameters such as width, height, thickness, or depth of each constituent element may vary according to the embodiments of the present invention except for parameters clearly defined in the specification. Therefore, if any configuration has the technical characteristics of the present embodiments which will be described hereinafter, it may be understood as one of the exemplary embodiments included in the technical scope of the present invention. In accompanying drawings, identically hatched blocks denote the same constituent elements.

The PDP 200 according to the present exemplary embodiment basically includes a front substrate 210, a rear substrate 220, a dielectric layer 222, a barrier rib 224, a phosphor layer 226, a scan electrode 228, and an address electrode 230. A space partitioned by the barrier rib 224 is defined as a discharge cell C.

Since the configuration and the structures of the front substrate 210, the rear substrate 220, the dielectric layer 222, the barrier rib 224 and the phosphor layer 226 are substantially equivalent to that of the front substrate 110, the rear substrate 120, the dielectric layer 122, the barrier rib 124, and the phosphor layer 126 according to the first embodiment, detailed descriptions thereof are omitted.

Hereinafter, the scan electrode 228 and the address electrode 230 will be described in more detail.

The function of the scan electrode 228 is identical to that of the scan electrode 128 according to the first exemplary embodiment. However, the shape and the arrangement of the scan electrode 228 are very much different from those of the scan electrode 128 according to the first exemplary embodiment.

The shape and the arrangement of the scan electrode 228 according to the present exemplary embodiment will be described with reference to FIG. 1.

Like the scan electrode 128 according to the first exemplary embodiment, the scan electrode 228 according to the present exemplary embodiment includes a line unit extending in a Y direction and a branch unit elongated from the line unit in an X direction.

Referring to the Z-X cross-sectional structure of the Y barrier ribs disposed at the right side and the left side among the Y barrier ribs in the PDP of FIG. 11, the scan electrode 228 is an electrode disposed at a lower end among electrodes formed inside the Y barrier rib.

The cross-section of the scan electrode 228 is the cross-section of the branch unit, and the branch unit has a length twice longer than a width of a discharge cell C in the X direction.

The address electrode 230 according to the present exemplary embodiment is identical to the address electrode 130 according to the first exemplary embodiment. However, the shape and the arrangement of the address electrode 230 are very much different from those of the address electrode 130 according to the first exemplary embodiment.

Hereinafter, the shape and the arrangement of the address electrode 230 according to the present exemplary embodiment will be described with reference to FIG. 1.

The address electrode 230 according to the present exemplary embodiment has a linear structure extending in the X direction like the address electrode 130 according to the first exemplary embodiment.

Unlike the address electrode 130 according to the first exemplary embodiment, which is disposed in Y barrier ribs at both sides of a discharge cell, the address electrode 230 according to the present exemplary embodiment is disposed at only one of the Y barrier ribs formed at both sides of a discharge cell.

Referring to the Z-Y cross-section of the PDP 200 of FIG. 11, a Y barrier rib with the address electrode 230 disposed and a Y barrier rib without the address electrode 230 disposed are alternatively disposed in the Y direction.

The address electrode 130 according to the first exemplary embodiment includes a pair of sub electrodes disposed inside Y barrier ribs corresponding to both sides of each discharge cell C, and a pair of sub electrodes is disposed in each Y barrier rib in parallel.

However, one address electrode 230 is disposed inside the Y barrier ribs according to the present exemplary embodiment, except for the junction of X barrier ribs, or is not disposed therein.

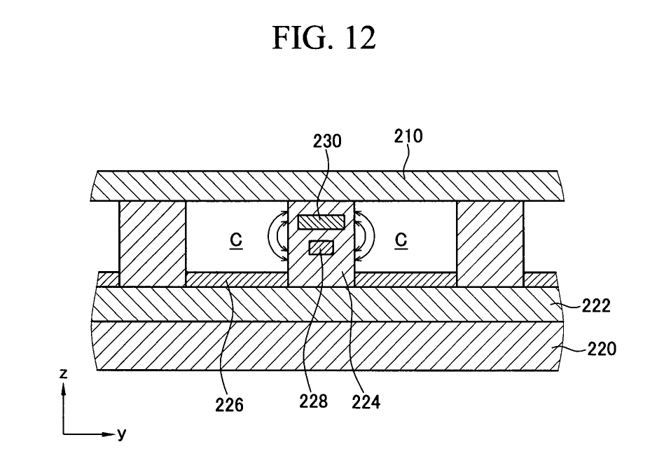

Hereinafter, the structures of the scan electrode 228 and the address electrode 230 in the PDP 200 according to the present exemplary embodiment shown in FIG. 12 will be described in detail.

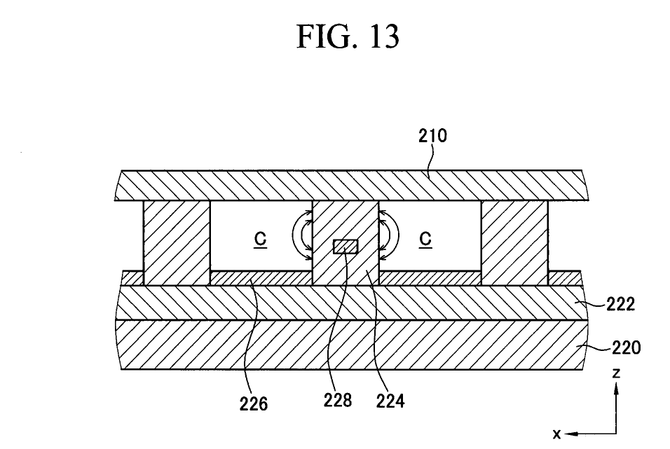

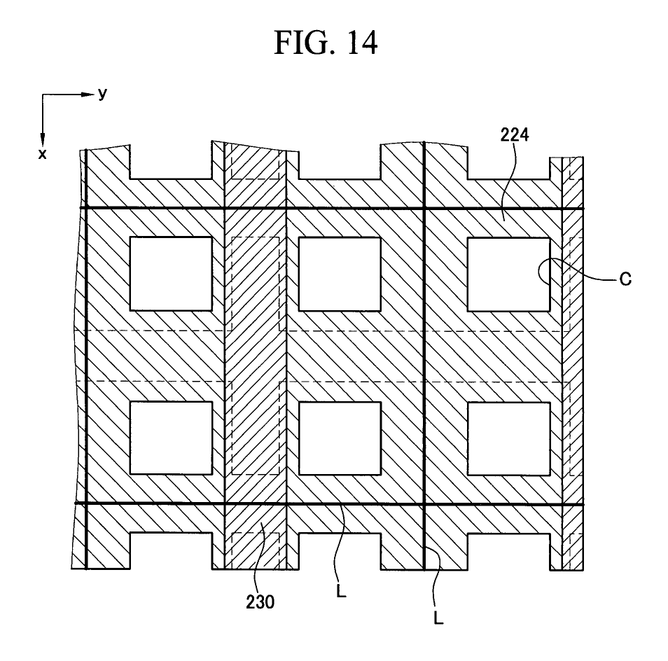

FIG. 12 is a Y-Z cross-sectional view taken along the line I-I of FIG. 11, FIG. 13 is an X-Z cross-sectional view taken along the line II-II of FIG. 11, and FIG. 14 is an X-Y cross-sectional view taken along the line III-III of FIG. 11.

Referring to FIG. 12, the discharge cells of the PDP 200 are partitioned by the front substrate 210, the dielectric layer 222 and the phosphor layer 226 formed on the rear substrate 220, and three barrier ribs 224.

Herein, the PDP 200 has an electrode structure in which the scan electrode 228 and the address electrode 230 are formed in the central one among three barrier ribs 224.

The scan electrode 228 and the address electrode 230 generate plasma discharge in two discharge cells C disposed at both sides of the barrier rib 224 where the scan electrode 228 and the address electrode 230 are formed.

Meanwhile, the sub-pixel of the PDP 200 is formed of two discharge cells disposed at both sides of the central one of the barrier ribs 224. The cross-section of the scan electrode 228 shown in FIG. 12 has a cross-section of a branch unit of the scan electrode 228.

FIG. 13 is an X-Z cross-sectional view taken alone the line II-II of FIG. 11.

Referring to FIG. 13, the discharge cells C of the PDP 200 are partitioned by the front substrate 210, the dielectric layer 222 and the phosphor layer 226 formed on the rear substrate 220, and three barrier ribs 224.

Also, the PDP 200 has an electrode structure in which the scan electrode 228 is disposed in only a central one of the three barrier ribs 224. The cross-section of the scan electrode 228 shown in FIG. 13 has a cross-section of a line unit of the scan electrode 228.

FIG. 14 is an X-Y cross-sectional view taken along the line III-Ill of FIG. 11.

More specifically, FIG. 14 further clearly illustrates an electrode shape of the PDP 200 and the relation between a discharge cell C and each of electrodes.

A scan electrode 228 lies directly under an address electrode 230 and a barrier rib 224. Therefore, the shape of the scan electrode 228 is illustrated using a dotted line. Also, an un-hatched rectangular area denotes a discharge cell C. A thick line L is used to clearly show each sub-pixel, and a rectangular area drawn with the thick line L denotes one sub-pixel.

Referring to FIG. 14, the address electrode 230 has a linear structure extending in an X direction.

Also, the sub-pixel surrounded with the thick line L at the center of FIG. 14 include four discharge cells C disposed at both sides of the address electrode 230.

Therefore, each of the sub-pixels corresponds to one address electrode 230 unlike the first exemplary embodiment, and it is not required to supply voltage to two address electrodes 230 disposed adjacent in a Y direction so as to interact with each other.

The address electrode 230 is separated upwardly (Z direction) from the scan electrode 228 drawn with a dotted line.

The scan electrode 228 includes a line unit elongated in the Y direction and a branch unit extending at both ends in the X direction from the line unit.

The line unit (branch electrode) is formed at a lower layer of the address electrode 230, and has a length exactly identical to the width of a Y barrier rib of a discharge cell C.

That is, the scan electrode 228 is separated from the address electrode 230 by a distance, and extends in a Y direction which crosses the address electrode.

Unlike the address electrode 230 of the first exemplary embodiment, the number of Y discharge cells C formed between a pair of branch electrodes increases from one to two.

In other words, the address electrodes 230 are formed inside sequentially disposed Y barrier ribs, with one Y barrier rib interposed among the Y barrier ribs arranged in the Y direction.

As a result, the address electrode 230 and the scan electrode 228 are disposed only at one of two Y barrier ribs which form the side walls of each discharge cell C. Therefore, it induces a plasma discharge so as to form a discharge path around the surface of one of two Y barrier ribs.

However, the focusing of plasma is generated because the multiplication of an internal pressure P and an opening diameter D is smaller than about 2.

Therefore, in the PDP 200, each discharge cell C can provide high discharge efficiency by disposing small discharge cell C adjacent to the address electrode 230 and the branch electrode, and an overall opening area can be secured in the discharge cell C corresponding to each sub pixel.

Up to now, the difference between the electrode structures of the PDP 200 according to the second exemplary embodiment and that according to the first exemplary embodiment has been described.

The structural characteristics of the PDP 200 according to the present exemplary embodiment are an electrode structure in which the branch unit (branch electrode) of the scan electrode 228 overlaps with one address electrode 230 separated by a predetermined distance therefrom, and a discharge cell structure in which a plurality of discharge cells C are formed around both sides of the branch electrode.

Hereinafter, exemplary variations of the second exemplary embodiment having the structural characteristics will be described with reference to accompanying drawings.

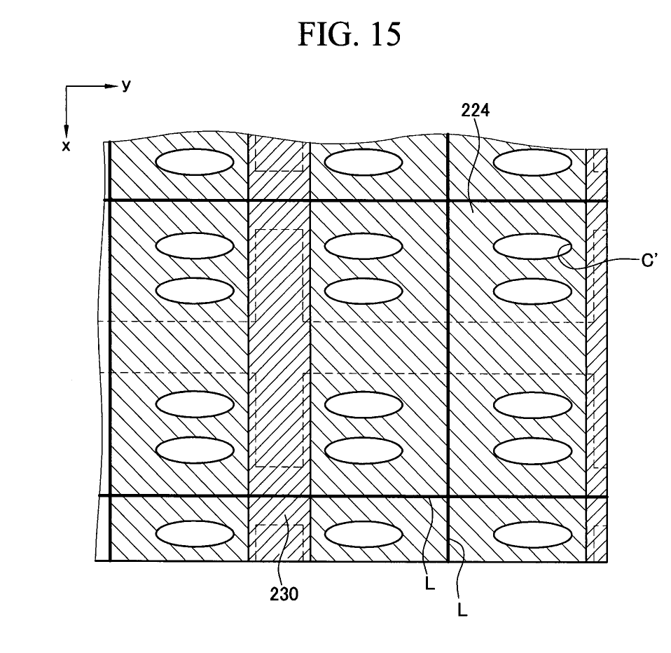

FIG. 15 is an X-Y cross-sectional view of a plasma display panel PDP according to an exemplary variation of the second exemplary embodiment taken along the line III-III.

Referring to FIG. 15, the PDP 200 according to the present exemplary variation includes one address electrode extending in the X direction, and a scan electrode 228 (drawn with a dotted line) extending in the Y direction under the address electrode 230 (equivalent to a lower layer located in the depth direction of FIG. 15) and having a branch electrode formed in a Y barrier rib 224.

In the PDP 200, a plurality of discharge cells C′ are formed at both sides of the address electrode 230.

Unlike the PDP 200 according to the second exemplary embodiment shown in FIG. 14, the shape of the discharge cell C′ changes from a rectangular parallelepiped shape to a cylindrical shape as a first characteristic, and the number of discharge cells disposed in each sub-pixel increases twice as a second characteristic.

The first and second characteristics of the present variation are identical to the first and second characteristics of the first exemplary variation of the first exemplary embodiment. Since the effects thereof are substantially equivalent, the descriptions thereof are omitted.

As described above, the first characteristic changes the cross section of discharge cells so as to dispose even more discharge cells in one sub-pixel.

Therefore, it is preferable to form the discharge cells so as to have a predetermined shape which allows the discharge cell C′ to be disposed closest to the address electrode 230 and the branch electrode in the PDP 200.

The second characteristic simultaneously induces plasma charge in the discharge cells C′ using a pair of discharge electrodes, for example, the address electrode 230 and the branch electrode of the scan electrode 228.

That is, the number of discharge cells C′ to be disposed in a discharge cell C′ is not limited in the PDP 200 shown in FIG. 15. That is, it is possible to simultaneously induce plasma discharge at all of the discharge cells C′ if the discharge cells C′ are disposed closer to one side or both sides of a pair of discharge electrodes.

Up to now, the PDP 200 according to the second exemplary embodiment of the present invention has been described.

As described above, the electrode structure and the discharge cell structure according to the present exemplary embodiment enable a plurality of small discharge cells C′ in each sub-pixel to simultaneously induce plasma discharge by means of the above-described configurations of the exemplary variations. Therefore, the PDP 200 according to the present embodiment provides high luminous efficiency.

Hereinafter, a manufacturing method of the PDP 100 and PDP 200 will be described.

Herein, a method for forming an electrode structure according to an exemplary embodiment of the present invention will be mainly described. Other constituent elements can be manufactured using a typical PDP manufacturing method, a manufacturing method substantially equivalent thereto, or a manufacturing method that will be introduced in the near future.

At first, a dielectric layer is formed so as to form a barrier rib on a rear substrate, and a scan electrode is formed thereon. The scan electrode is patterned using photolithography so as to have an extremely long length in a direction crossing an address electrode that will be formed in a following process, and has a minimum area for overlap with the address electrode.

For example, the scan electrode may be formed in a ladder shape. In this case, discharge cells surround an electrode and are disposed in aciniform.

Then, a dielectric layer is formed between electrodes to form a discharge gap. An address electrode is formed thereon.

The address electrode is formed using the same method as is used to form the scan electrode, and is patterned using Ag paste having photosensitivity.

The address electrode is disposed so as to cross the scan electrode three-dimensionally, and one pixel may be selected by selecting one of the scan electrode and the address electrode.

Then, a discharge cell is formed at a target area. For example, the discharge cell may be formed using a sandblast method. That is, a groove or a hole is formed by patterning a dry film resist (DFR) at a target area so as to form a discharge cell, and by removing a dielectric layer of the target area. Herein, the scan electrode and the address electrode, covered with a proper thickness of dielectric layer, must be formed at the interior wall of the hole.

In order to embody the PDP according to an exemplary embodiment of the present invention, it is necessary to pattern a DFR so as to form a plurality of discharge cells which surround a pair of discharge electrodes in an aciniform.

After forming a plurality of the discharge cells, a MgO layer is formed on the surface of each discharge cell using an EB deposition method. For example, the MgO layer is formed at a thickness of about 700 nm. Through the above described processes, a discharge structure is formed on the rear substrate.

In order to increase luminance, a phosphor layer having the same color can be formed in a plurality of discharge cells which form one pixel. Also, a phosphor layer is formed at a surface area corresponding to each pixel on the front substrate. Furthermore, it is preferable to form a Black Matrix (BM) as a partition of each pixel.

Herein, it is important to form the phosphor layer on the front substrate so as to have the same color of a plurality of the discharge cells which form each pixel on the rear substrate in order to observe light emitting from each discharge cell through the phosphor layer.

It is also preferable to form the phosphor layer on the front substrate at a maximum thickness of about 20 μm. The thickness of the phosphor layer may be properly decided according to the material of the phosphor.

As described above, in the plasma display panel PDP according to the present invention, a plurality of small discharge cells forming a sub-pixel can simultaneously emit light by means of the branch electrode and the second electrode. Also, luminous efficiency can be improved by inducing plasma discharge from each of the discharge cells, and the overall opening area of the discharge cells can be sufficiently secured according to the present embodiment. Therefore, the high luminance can be achieved by emitting light using plasma.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For example, although the address electrode was described as the first electrode, and the scan electrode was described as the second electrode in the description of the exemplary embodiments, the present invention is not limited thereto. It is possible to describe the address electrode as the second electrode and the scan electrode as the first electrode.

Also, in addition to the first electrode and the second electrode, a third electrode having the same shape as the first electrode may be included. For example, a third electrode having the same shape as the scan electrode may be disposed directly on the address electrode as a three-electrode structure in the first exemplary embodiment.

In this case, a discharge structure is formed to include an address discharge generated from the address electrode and a sustain discharge generated from the scan electrode and the third electrode.

Similarly, a third electrode having the same shape as the scan electrode may be formed directly on the address electrode as a three-electrode structure in the second exemplary embodiment.

In this case, a discharge structure is formed and includes an address discharge generated by the address electrode and a sustain discharge generated by the scan electrode and the third electrode.

What is claimed is:

1. A plasma display panel, comprising:
a front substrate and a rear substrate facing each other; and
a barrier rib disposed between the front substrate and the rear substrate for partitioning a plurality of discharge cells;
wherein the barrier rib includes:
a plurality of first barrier ribs arranged in a first direction; and
a plurality of second barrier ribs arranged in a second direction which crosses the first direction;
wherein first electrodes are formed in the first barrier ribs at an interval of N first barrier ribs among the first barrier ribs arranged in the first direction, where N is a natural number;
wherein second electrodes are formed in the second barrier ribs so as to cross the first electrodes three-dimensionally; and
wherein branch electrodes are disposed in the second barrier ribs, overlapping with at least one of the second electrodes, and extending from the first electrodes.

2. The plasma display panel of claim 1, wherein each second electrode includes a pair of sub-electrodes disposed at both sides of the discharge cell.

3. The plasma display panel of claim 2, wherein said each second electrode includes a bride electrode for connecting a pair of the sub-electrodes.

4. The plasma display panel of claim 3, wherein each branch electrode is disposed directly on one of the second electrodes.

5. The plasma display panel of claim 3, wherein each branch electrode is disposed directly below one of the second electrodes.

6. The plasma display panel of claim 1, wherein each discharge cell is formed so as to have one of a circular cross-section and a polygon cross-section.

7. The plasma display panel of claim 1, further comprising third electrodes having a same shape as the first electrodes, said each of said third electrodes being separated from one of the first electrodes by a distance so as to insert one of the second electrodes therebetween, and each of said third electrodes inducing a plasma discharge between one of the first electrodes and one of the second electrodes.

8. The plasma display panel of claim 1, further comprising third electrodes having a same shape as the second electrodes, each of said third electrodes being separated from one of the second electrodes by a distance so as to insert one of the first electrodes therebetween, and each of said third electrodes inducing a plasma discharge between one of the second electrodes and one of the first electrodes.
